(19) United States
(12) Patent Application Publication
(10) Pub. No.: US 2020/0180955 A1
(43) Pub. Date: Jun. 11, 2020

(54) PROCESS FOR HIGH-YIELD PRODUCTION OF HYDROGEN FROM A SYNTHESIS GAS, AND DEBOTTLENECKING OF AN EXISTING UNIT

(71) Applicant: L'Air Liquide, Société Anonyme pour I'Etude et I'Exploitation des Procédés Georges Claude, Paris (FR)

(72) Inventor: Laurent ALLIDIERES, Saint Martin d'Uriage (FR)

(21) Appl. No.: 16/623,144

(22) PCT Filed: Jun. 27, 2017
(86) PCT No.: PCT/FR2017/051720

§ 371 Date: Dec. 16, 2019

(51) Int. Cl. C01B 3/48; C01B 3/56

(52) U.S. Cl. CPC C01B 3/48; C01B 3/56; C01B 2203/043; C01B 2203/0475; C01B 2203/127; C01B 2203/148; C01B 2203/047

(57) ABSTRACT

Process for debottlenecking a plant that produces hydrogen including reforming of hydrocarbons, then conversion of CO, purification of hydrogen by PSA-H2 for the production of a high-pressure gaseous stream of ultra-pure hydrogen with associated production of a low-pressure residue, the two major constituents of which are carbon dioxide and hydrogen, the debottlenecking of the plant is carried out by installing, level with the PSA residue, an EHS electrochemical cell for supplying, from the PSA residue, hydrogen and a hydrogen-depleted residue, the additional hydrogen stream recovered in the EHS cell is compressed and sent to the inlet of the PSA unit thus increasing the hydrogen production of the plant while keeping the purity of the hydrogen produced by the PSA unchanged. The invention also relates to a process and a plant for producing hydrogen having an optimized hydrogen yield.

### CROSS REFERENCE TO RELATED APPLICATIONS

This application is a 371 of International PCT Application PCT/FR2017/051720, filed Jun. 27, 2017, the entire contents of which is incorporated herein by reference.

### BACKGROUND

The present invention relates to a process for producing hydrogen by hydrocarbon reforming, it also relates to a method for debottlenecking an existing hydrogen production plant, and also to a hydrogen production plant.

Hydrogen production systems are usually based on the reforming of light hydrocarbons (light hydrocarbons are usually understood to mean methane, generally in the form of natural gas or biomethane, but also naphtha and methanol, amongst others), they also use partial oxidation or autothermal reforming processes; these production systems generate gas mixtures containing very predominantly hydrogen and carbon monoxide, but also carbon dioxide, water and also trace compounds, these mixtures being known under the name of synthesis gas or syngas. Steam reforming is the most commonly used among these systems, it makes it possible to produce around 90% of the hydrogen currently consumed in the world, as much to meet industrial needs as those related to mobility.

Most of the time, the plants correspond to investments made in connection with long-term gas supply contracts, and it is very difficult initially to predict what the change in demand will be (new customers and/or increase in the requirements of existing customers), so that the problem frequently arises of increasing the hydrogen production capacity of the plant while minimizing the investment necessary for achieving this.

The invention presented below makes it possible to increase the recovery yield of the hydrogen produced by conventional hydrogen production plants, from a value of between around 75% and 90% depending on the size of the plant and operating parameters to a value close to 99%, irrespective of the size of the plant.

Indeed, these plants typically comprise a unit for purifying hydrogen by pressure swing adsorption, more commonly identified as a PSA hydrogen or PSA H₂ unit.

The conventional diagram of a plant for producing hydrogen by steam methane reforming (SMR) is reproduced in FIG. 1 and can be summarized as follows.

The pressurized feedstock (natural gas, mixture of light hydrocarbons or other feedstock of the same type) is, depending on its composition, desulfurized, optionally pre-reformed, and is then reformed to produce a synthesis gas containing essentially H₂, CO₂, CO, with, in lower amounts, CH₄ and N₂ and also water vapor. When the synthesis gas is produced from the point of view of ultimate production of hydrogen, it then generally passes into one or more reactors referred to as “shift” reactors where the carbon monoxide is converted into carbon dioxide by reaction with steam, thereby producing additional hydrogen.

The synthesis gas leaving the shift reactor, and after cooling to room temperature and removing the process condensates, contains approximately 75% to 82% hydrogen, 2% to 3% carbon monoxide, 10% to 20% carbon dioxide, 0.3% to 4% methane, and also trace compounds, including, depending on the case, nitrogen.

In order to produce pure hydrogen, a further purification is then carried out that uses PSA technology which makes it possible to produce a gaseous stream of ultrapure hydrogen.

However, although the PSA purification process provides a very high quality product, it makes it possible on other hand to recover only around 75% to 90% of the hydrogen entering the PSA depending on the complexity of the PSA cycle (in particular the number of equilibrations and adsorbers), depending also on the flow rate. To compensate for the loss of hydrogen in the PSA, it is necessary to increase the size of the reformer to achieve the desired production. The reformer must furthermore be capable of operating at a high pressure, of the order of 25 bar to produce a syngas at a sufficient pressure for the downstream treatment, and in particular to optimize the operation of the PSA, this further increases the cost of the reformer.

According to the conventional operating diagram of this type of plant, the purge gases from the PSA are used as fuel gas for the reformer.

Various known solutions aiming to “debottleneck” hydrogen production plants are presented below:
lowering the purity of the hydrogen produced by an adjustment of the PSA; 2 to 3 additional PSA yield points (i.e. an increase in the yield from 78% to 81% for a system with 4 adsorbers and one equilibration) may for example be gained on moving from 1 ppm CO to 10 ppm CO, i.e. up to 5% additional production (81/78=3.8%)
   advantage: no shutdown of the plant;
   disadvantages: the new lower purity may not be compatible with the customer specification, the increase in productivity is low;
changing the reformer catalysts (possible increase in production of 5-8%);
   advantage: can be carried out during a scheduled change (every 4 to 5 years);
   disadvantages: very expensive operation since it requires the shutdown of the plant, gain in productivity not always obvious and sometimes unstable over time, the PSA may remain the limiting element;
changing the PSA adsorbents (possible increase in production of 2-5% depending on the adsorbents);
   advantage: increase in productivity;
   disadvantages: very expensive operation, the plant must be shut down, the adsorbents do not generally need to be changed;
addition of an HTS (High Temperature Shift) and/or an LTS (Low Temperature Shift) (possible increase in production of 5%);
   advantage: productivity gains;
   disadvantages: the operation is very expensive, the plant must be shut down, the operating conditions of the plant must be modified (steam/carbon ratio), the PSA may be the limiting element; moreover, the plants designed to produce hydrogen already have for the most part a shift reactor—an HTS and sometimes an LTS;
changing the PSA for a higher yield PSA (possible productivity gain of 5%);
   advantage: increase in productivity;
   disadvantages: the operation is very expensive, the plant must be shut down, the investment is very high.

If a conventional reforming plant of the type of the one from FIG. 1 is considered, the larger its size, the higher its yield because the higher the yield of the PSA cycle (greater number of equilibrations of the cycle), while the yield of the furnace remains substantially identical. Indeed, for a gas originating from a conventional reformer, different PSA cycles (with different numbers of adsorbers) are used depending on the flow rate with different typical yields as shown in Table 1 below.

TABLE 1
PSA conventional yield as a function of H₂ production

| PSA (no. of | | | | | |
|---|---|---|---|---|---|
| adsorbers) | 4 | 5 | 6 | 8 | 10 |
| H₂ flow rate | 100- | 2000- | 10000- | 20000- | 50000+ |
| (Nm³/h) | 2000 | 10000 | 25000 | 50000 | |
| PSA H₂ yield | 78-80% | 82-84% | 84-86% | 85-87% | 87-89% |

Due to the limited yield of the PSA, the PSA waste therefore has a high content of hydrogen—as illustrated by the example reported in table 2 presented below—and this being even more so when the plant is of small size. If this hydrogen can be recovered as a product, it generally has a much higher value than it may have as a fuel.

Thus, recovering (some of) the hydrogen from the gaseous waste of the PSA may make it possible to better upgrade the synthesis gas produced by the reformer, and may thus make it possible to meet new hydrogen requirements without resorting to expensive solutions of limited efficiency as listed above, provided that this additional hydrogen can be produced under satisfactory purity and cost conditions.

The electrochemical purification of hydrogen using proton exchange membranes—or PEM membranes—is known, it is described in particular in document US2015/0001091 A1.

It is also known from US2014/0332405 A1 to increase the yield of a hydrogen production plant by recovering additional hydrogen present in the low-pressure gaseous waste from the PSAH₂ purification unit. The solution consists in supplying an electrochemical cell from said low-pressure gaseous waste so as to separate additional hydrogen from said low-pressure gaseous waste, the additional hydrogen stream produced by means of the PEM membrane is recovered and combined with the high-pressure hydrogen produced by the PSA unit with the result of increasing the amount of hydrogen produced by the plant.

It is also known from US2014/0311917 A1 to apply the electrochemical purification of hydrogen directly to the synthesis gas leaving the reformer.

However, the methods described above do not make it possible to achieve high hydrogen purities, and in particular hydrogen purities compatible with the ISO standard relating to the purity of hydrogen intended for fuel cells (ISO 14687), particularly the CO specification of 0.2 ppm and H₂O specification of 5 ppm for the following reasons:
CO-resistant membranes operate at high temperature (more than 100-120° C.), gaseous diffusion of CO through the cathode occurs naturally (Fick's law) so that there remains around 0.05% CO at the cathode;
this electrochemical membrane separation system operates under wet conditions, the hydrogen produced thus contains water, at a content higher than the limit set by the ISO 14687 standard which is 5 ppm of H₂O.
   There is therefore a need for a simple process that:
makes it possible to upgrade as best as possible almost all the hydrogen present in a synthesis gas, without having too high an additional cost compared to the cost of a purification via a simple PSA H₂ unit;
preserves the very high purity of the hydrogen produced;
can be applied to any new hydrogen production plant using PSA H₂ purification, irrespective of its size;
can be used on an existing plant, thus making it possible to debottleneck the plant and meet additional hydrogen requirements.

The invention therefore aims to increase the hydrogen yield of a hydrogen production plant—by reforming natural gas (or comparable feedstock) and purification of hydrogen by PSA—preserving the purity of the product and at a lower cost.

### SUMMARY

The solution according to the invention consists in installing an electrochemical hydrogen purification system/cell that functions using a proton exchange membrane-referred to as an EHS (Electrochemical Hydrogen Separation) system—installed on the PSA waste gas (fluid 14 in the figures) and combined with a recirculation of purified and compressed hydrogen (mechanical or electrochemical compression combined with the separation step in the same electrochemical cell) at the inlet of the PSA so as to increase the overall yield of an existing plant, while maintaining the quality of the hydrogen produced.

For this purpose, the invention relates to a method for debottlenecking a hydrogen production plant comprising a module for generating a synthesis gas by reforming from light hydrocarbons, optionally a shift module for enrichment in hydrogen and carbon dioxide by conversion of the carbon monoxide contained in the synthesis gas with water vapor, a PSA-H₂ unit for the purification of hydrogen and the production of a high-pressure gas stream of ultrapure hydrogen, in particular in accordance with the ISO14687 standard, with associated production of a low-pressure gaseous waste (PSA waste), the two major constituents of which are carbon dioxide and hydrogen, according to which method an electrochemical hydrogen purification cell is installed on the PSA low-pressure gaseous waste so as to separate hydrogen and a hydrogen-depleted waste (EHS cell waste) from said PSA waste, the hydrogen being recovered to form an additional hydrogen stream which is compressed to a pressure of between 8 and 25 bar and sent entirely or in part to the inlet of the PSA unit to increase the hydrogen production of the plant while keeping the purity of the hydrogen produced by the PSA unchanged.

In this way, owing to the solution of the invention, the hydrogen production of the plant is increased while keeping the purity of the hydrogen produced by the PSA unit unchanged. The purification module of the plant—combining the PSA and the electrochemical hydrogen separation cell (EHS system) installed on the waste with recirculation at the inlet of the PSA—then ensures an overall hydrogen yield of the plant of close to 99% when all of the additional hydrogen stream originating from the cell is sent to supply the PSA. The purity of the hydrogen produced at the outlet of the PSA itself remains unchanged.

According to another aspect of the invention, it relates to a hydrogen production process, the overall yield of which is optimized from the moment of its design. Indeed, installing an EHS cell on the PSA waste may also be carried out during the installation of a new plant, it makes it possible in this case to directly have an optimized yield of very pure hydrogen, without having to oversize the units located upstream of the PSA.

For this purpose, the invention relates to a hydrogen production process comprising at least the steps of:

a) generating, by reforming, a synthesis gas from a light hydrocarbon feedstock,

b) optionally enriching the synthesis gas with hydrogen and carbon dioxide by steam conversion of the carbon monoxide to give carbon dioxide,

c) purifying the enriched synthesis gas for the production of a high-pressure gas stream of ultrapure hydrogen by pressure swing adsorption (PSA-H2) with associated production of a low-pressure gaseous PSA waste, the two major constituents of which are carbon dioxide and hydrogen,

d) supplying an electrochemical cell (EHS cell) with all or part of the low-pressure PSA waste in order to recover additional hydrogen from the PSA waste, and a hydrogen-depleted waste (cell waste),

e) compressing the additional hydrogen recovered to a pressure of between 8 bar and 25 barg,

f) recycling all or part of the compressed recovered additional hydrogen in the process upstream of the PSA unit to supply the PSA so as to increase the production yield of very high purity hydrogen of the plant.

The use of the electrochemical membrane for the separation of hydrogen from the waste in addition to the PSA according to the invention, whether for debottlenecking or ab initio, has several advantages:
the EHS electrochemical cell is supplied with a low-pressure gas, the PSA waste can therefore be used as it is produced by the PSA without prior compression;
by supplementing the PSA feed with the gaseous “supplement” very rich in hydrogen (98% for example) originating from the EHS cell, the hydrogen content of the PSA feed gas is significantly increased, the yield and the productivity of the PSA are themselves also significantly improved—as shown by the example presented later in the description.
   Advantageously, the invention has one or more of the following variants:
the step e) of compressing the additional hydrogen recovered is carried out at least in part by the electrochemical cell; indeed, if the potential applied to the electrochemical cell is increased, this cell can also compress the hydrogen that it produces; it is an alternative—or a supplement—to another means of compressing the flow of hydrogen produced by the membrane, for example to a mechanical compressor for the compression necessary before supplying the PSA;
a portion of the hydrogen recovered from the EHS cell is used to desulfurize the light hydrocarbon feedstock to be reformed;
a portion of the recovered hydrogen leaving the EHS cell is used to directly supply a customer having a low purity requirement; provision may also be made, in times of a reduction in the need for ultrapure hydrogen, for the hydrogen leaving the cell to be used temporarily for other purposes, without being recycled to the PSA;
in the event of production of excess hydrogen, the operation of the electrochemical cell is interrupted so as to optimize the power consumption of the plant;
all or part of the cell waste—H₂-depleted waste leaving the membrane—is recovered to produce carbon dioxide.

According to another aspect of the invention, it relates to a plant for producing hydrogen from a light hydrocarbon feed stream having an optimized yield comprising at least:
a module for generating, by reforming, a synthesis gas from said light hydrocarbon feed stream;
an optional module for steam conversion of the carbon monoxide to give carbon dioxide, for enriching the synthesis gas with hydrogen and carbon dioxide;
a PSA-H₂ unit for purifying the hydrogen contained in the synthesis gas with production of an outgoing high-pressure gas stream of ultrapure hydrogen and associated production of a low-pressure outgoing gaseous PSA waste, the two main constituents of which are carbon dioxide and hydrogen;
an electrochemical cell (EHS cell) capable of being supplied by the low-pressure gaseous PSA waste and capable of separating hydrogen present in the PSA waste from the other constituents so as to produce a hydrogen stream and a hydrogen-depleted waste (EHS cell waste);
a means for compressing the hydrogen stream separated by the EHS cell;
a means for treating and/or a means for using the EHS cell waste;
and also means for discharging, conveying and supplying the various streams used.

Advantageously, the plant according to the invention has one or more of the following variants:
the electrochemical cell is capable of carrying out, at least in part, the compression of the additional hydrogen recovered;
the plant comprises means for compressing and transferring at least a portion of the additional hydrogen recovered at the outlet of the electrochemical cell to a module for desulfurization of the light hydrocarbon feedstock;
the plant comprises means for using the hydrogen-depleted waste leaving the electrochemical cell (EHS cell waste) as a fuel for the reforming and/or for producing carbon dioxide.

### BRIEF DESCRIPTION OF THE DRAWINGS

The invention will be better understood by virtue of the following description given with reference to the appended figures, among which:

FIG. 1 is a block diagram of a conventional hydrogen production plant;

FIG. 2 is a block diagram of a hydrogen production plant of the same type, but debottlenecked in accordance with the invention.

### DETAILED DESCRIPTION OF THE PREFERRED EMBODIMENTS

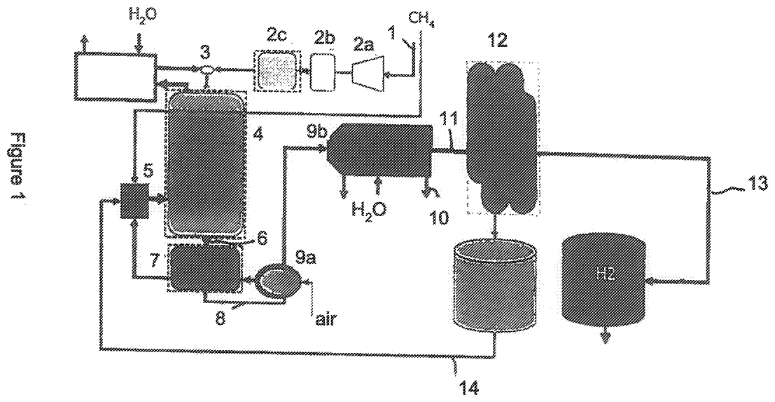

According to the conventional diagram of FIG. 1, a hydrocarbon feedstock 1 intended to produce the hydrogen is subjected to a(n) (optional) compression step 2a, then to a desulfurization step 2b and to a(n) (optional) preforming step 2c, before being mixed—after preheating, not shown—with water vapor at the mixing point 3 and then introduced into a steam reforming reactor 4 where it is reformed at high temperature by means of external heat supplied by burners 5 installed in the walls of the reactor 4—it being possible for the burners to be installed in the side walls, installed in a terraced manner, in the crown or in the floor depending on the manufacturers—to produce a synthesis gas 6, a mixture containing for the most part the hydrogen and carbon oxides—mainly CO.

The synthesis gas 6, also known as syngas, is produced at high temperature (of the order of 600° C.-800° C.) and high pressure, it is then enriched in H₂ and CO₂ in a shift reactor 7 by conversion of the CO by the excess water vapor present in the syngas to produce the hydrogen-enriched syngas 8.

After cooling in 9a and 9b to room temperature and with separation of the condensates 10, the syngas enriched in H₂ and CO₂ and cooled 11 supplies a PSA unit 12.

In terms of small production, for example for a hydrogen flow rate of less than 2000 Nm³ of H₂, the H₂ yield of the PSA is of the order of 78-80% for 4 adsorbers; and as reported in table 1, it increases in the case of large-sized plants reaching 88-89% for 10 adsorbers for plants producing 50 000 Nm³/h or more.

The PSA unit 12 produces ultrapure hydrogen 13 under pressure, and also a low-pressure gaseous waste 14 which combines all the components present in addition to hydrogen in the syngas 11 supplying the PSA, i.e. the very predominant CO₂, but also CO, residual CH₄, water vapor, nitrogen, but also alongside these gases, hydrogen in a proportion that is greater, the smaller the plant is.

The hydrogen produced 13 passes (optionally) into a production buffer tank (not referenced) in order to smooth out the pressure and flow rate variations related to the PSA cycles. A buffer capacity 14 is installed on the PSA waste gas to smooth out variations in pressure, flow rate and composition of the waste gas that could affect the correct operation of the reforming furnace burners.

The waste gas is used as fuel gas, especially for heating the reformer, owing to its hydrogen and methane contents.

The diagram does not reproduce the complexity of the plant; among the elements of the overall process—not necessary for the understanding of the invention—only some are present (referenced or not): heat exchanger 9b between the syngas 8 and water with recovery of the condensates 10 upstream of the PSA, supply and preheating of the combustion air, supply of water to the plant with heating in the convection chamber of the reformer against the flue gases and in the exchanger 9b against the syngas etc.

The material balance of the hydrogen recovery for a plant of conventional type such as the one from FIG. 1 on the basis of a PSA with 4 adsorbers is presented in tables 2A, 2B and 2C below.

TABLE 2A
compositions in mol %

| Fluid reference | 11 | 14 | 13 |
|---|---|---|---|
| Components | % | % | % |
| Hydrogen H₂ | 76.4 | 39.2 | >99.99 |
| Nitrogen N | 00.2 | 00.6 | <100 ppm |
| Methane CH₄ | 03.5 | 08.9 | <10 ppm |
| Carbon monoxide CO | 02.0 | 05.1 | <10 ppm |
| Carbon dioxide CO₂ | 17.7 | 45.5 | <10 ppm |
| Water H₂O | 00.3 | 00.7 | <10 ppm |
| Total | 100.0 | 100.0 | 100.0 |

TABLE 2B
Parameters (Temperature, Pressure, Flow Rates)

| Temperature ° C. | 35 | 35 | 35 |
|---|---|---|---|
| Pressure in barg | 21 | 0.01 | 20 |
| Flow rate Nm³/h | 1000 | 389.12 | 610.88 |

TABLE 2C
How Rates (Nm³/h)

| | | | |
|---|---|---|---|
| Hydrogen H₂ | 763.60 | 152.72 | 610.88 |
| Nitrogen N | 002.40 | 002.40 | — |
| Methane CH₄ | 034.70 | 034.70 | — |
| Carbon monoxide CO | 019.70 | 019.70 | — |
| Carbon dioxide CO₂ | 176.90 | 176.90 | — |
| Water H₂O | 002.70 | 002.70 | — |

Overall, the hydrogen efficiency of this conventional plant is that of the PSA, it is therefore 80% (=H₂ flow rate of stream 13/H₂ flow rate of stream 11).

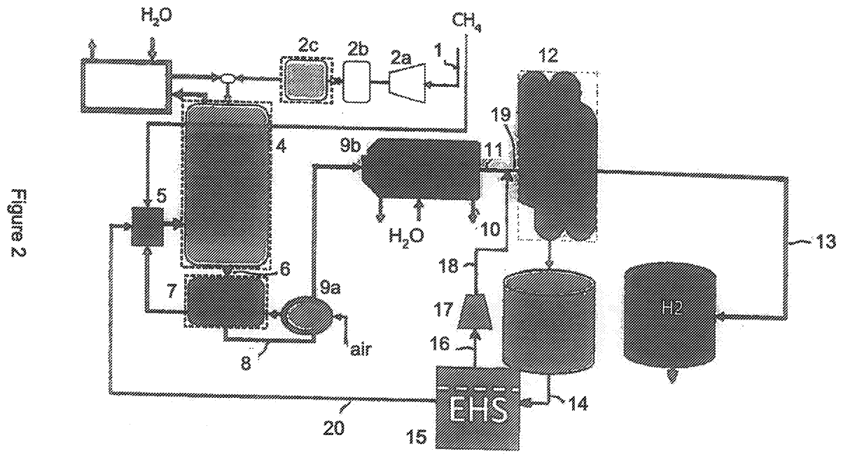

The diagram of FIG. 2 represents a plant deduced from that of FIG. 1, but which has been debottlenecked in accordance with the invention. The elements of FIG. 1 that are in FIG. 2 bear the same references, in particular all the fluids and means participating in the generation of the synthesis gas upstream of the purification of hydrogen.

Thus, the hydrocarbon feedstock 1 is here also compressed, desulfurized and prereformed in 2a, 2b, 2c before being mixed with the water vapor at the mixing point 3 and then introduced into the steam reforming reactor 4 where it is reformed at high temperature by means of external heat supplied by burners 5 to produce the synthesis gas (or syngas) 6.

The syngas at high temperature and high pressure is enriched in H₂ and CO₂ in a shift reactor 7 by reaction between water vapor and the CO present in the syngas.

After cooling to room temperature and separation of the condensates, the syngas 11 enriched in H₂ and CO₂ is sent to the PSA unit.

The PSA unit 12 produces very high purity hydrogen 13 under pressure, and also the low-pressure gaseous PSA waste 14.

The hydrogen produced 13 passes (optionally) in a production buffer tank (not referenced) in order to smooth out the pressure and flow rate variations related to the PSA cycles. A buffer capacity 14 is installed on the PSA waste gas in order to smooth out variations in pressure, flow rate and composition of the PSA waste gas.

In accordance with the invention, the waste gas 14 supplies an electrochemical purification cell 15 which operates in the following manner: the electrochemical cell separates the constituents of the waste 14 from the hydrogen and thus produces hydrogen 16 and a second gas stream 20 containing essentially all of the gases present in the PSA waste 14 with only a few percent of hydrogen. This second gas stream 20 (identified as EHS cell waste) is—in the example—used as a fuel gas for heating the reformer. Other uses known per se are possible depending on the circumstances and requirements. The hydrogen 16 is compressed in 17, the gas thus compressed 18 is combined with the syngas 11 to form a new feed gas 19 for the PSA 12.

The material balance of the hydrogen recovery for a plant of conventional type such as the one from FIG. 1 is presented in tables 3A, 3B and 3C below which present a (new) material balance calculated for the debottlenecked unit:

TABLE 3A
compositions in %

| Fluid | | | | | | | |
|---|---|---|---|---|---|---|---|
| reference | 11 | 19 | 14 | 20 | 16 | 18 | 13 |
| Components | % | % | % | % | % | % | % |
| H₂ | 76.4 | 79.1 | 37.6 | 3.0 | 98.40 | 98.40 | >99.99 |
| N | 0.2 | | 0.6 | 1.0 | 00.05 | 00.05 | <100 ppm |
| CH₄ | 3.5 | | 9.1 | 14.2 | 00.05 | 00.05 | <10 ppm |
| CO | 2.0 | | 5.2 | 8.1 | 00.05 | 00.05 | <10 ppm |
| CO₂ | 17.7 | | 46.2 | 72.6 | 00.05 | 00.05 | <10 ppm |
| H₂O | 0.3 | | 1.2 | 1.1 | 01.40 | 00.30 | <10 ppm |
| Total | 100.0 | 100.0 | 100.0 | 100.0 | 100.00 | 98.90 | 100 |

TABLE 3B
Parameters (Temperature, Pressure, Flow Rates)

| | | | | | | | |
|---|---|---|---|---|---|---|---|
| Temper- | 35 | 35 | 35 | 35 | 35 | 35 | 35 |
| ature | | | | | | | |
| Pressure | 21 | 0.01 | 0.01 | 0.01 | 15 | 21 | 20 |
| in | | | | | | | |
| barg | | | | | | | |
| Flow | 1000 | 1139.1 | 382.70 | 243.60 | 139.10 | 139.10 | 756.40 |
| rate | | | | | | | |
| Nm³/h | | | | | | | |

TABLE 3C
(Nm³/h)

| | | | | | | | |
|---|---|---|---|---|---|---|---|
| H₂ | 763.60 | 900.47 | 144.08 | 7.20 | 136.87 | 136.87 | 756.40 |
| N | 2.40 | 2.47 | 2.47 | 2.40 | 0.07 | 0.07 | |
| CH₄ | 34.70 | 34.77 | 34.77 | 34.70 | 0.07 | 0.07 | |
| CO | 19.70 | 19.77 | 19.77 | 19.70 | 0.07 | 0.07 | |
| CO₂ | 176.90 | 176.97 | 176.97 | 176.90 | 0.07 | 0.07 | |
| H₂O | 2.70 | 4.65 | 4.65 | 2.70 | 1.95 | 1.95 | |

in which the estimated compression power is 51.64 kW, the estimated EHS power is 23.24 kW.

The overall hydrogen efficiency is 99% (Table 3C: fluid 13 values/fluid 11 values) with an EHS hydrogen efficiency of 95% (Table 3C: fluid 16 values/fluid 14 values), and a PSA hydrogen efficiency of 84% (Table 3C: stream 13 values/stream 19 values).

In the example presented here, for the same flow rate as in the conventional version without EHS, the flow rate of hydrogen produced (with identical purity) thus changes from 610 Nm³/h to 756 Nm³/h, an increase of 24% for a maximum additional electricity requirement of 75 kW.

This additional electricity requirement can be advantageously reduced (to around 40 kW) by combining the electrochemical purification step and the compression step in the same electrochemical cell.

The separation of hydrogen by proton exchange membrane PEM—carried out in the EHS cells—applied to the separation of hydrogen contained in the PSA gaseous waste functions in the following manner: the PSA gaseous waste, available at a temperature of the order of room temperature and at a pressure of 300 to 500 mbar above atmospheric pressure supplies an electrochemical cell which contains catalyst-covered electrodes on either side of a membrane. When the electric current passes into the electrodes, the PEM membrane used in the EHS cell allows the hydrogen—in H₃O⁺ form—to pass selectively through the membrane, so that pure hydrogen is recovered from the other side.

The reactions involved are:

At the anode: ½ H₂=>H⁺ e−

At the cathode: H⁺ e−=>½ H₂

Ultimately, the balance is: H₂=>H₂, hydrogen being transferred from the anode compartment to the cathode compartment.

The electrochemical potential is:

$${E}^{cathode} - {E}^{anode} = - \frac{R \cdot T}{2 \cdot F} ln ( \frac{{P}_{{H}_{2}}^{Cathode}}{{P}_{{H}_{2}}^{Anode}} )$$

At the same time, the membrane thereby creates a second stream containing the other compounds of the PSA waste, which cannot pass through the membrane which rejects them; they form the “rejected” stream. This rejected stream—the stream 20 of FIG. 2 and the example—is therefore the waste gas of the EHS within the meaning of the invention. It could, depending on its composition, be actually rejected, or treated and/or reused in other processes, or used as fuel in the reforming furnace as shown in the example presented.

As for the hydrogen thus recovered at the outlet of the EHS cell, it does not have a sufficient purity to be added to the hydrogen produced by the PSA, the quality of which it would greatly degrade, after compression. On the other hand it is perfectly suitable for being recycled to feed the PSA. It should be noted that the hydrogen can also be simultaneously compressed.

Among the advantages of the invention, mention will be made of:
increase in the hydrogen production of an existing plant in proportions much greater than those that can be achieved by conventional debottlenecking means;
no modifications of the plant requiring expensive work;
preserving the purity of the hydrogen gas produced;
in the case of a new plant, adopting the solution of the invention during construction, production of very high purity hydrogen with a maximum hydrogen yield, oversizing of the other equipment (SMR notably) can then be avoided;
possibility of recovering the second fluid produced by the EHS cell (stream 20 in FIG. 2) lean in H₂ and rich in CO₂ in order to produce CO₂ if this is upgradable or in order to capture CO₂ if need be.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

1.-11. (canceled)

12. A method for debottlenecking a hydrogen production plant comprising;
a module for generating a synthesis gas by reforming from light hydrocarbons,
a shift module for enrichment in hydrogen and carbon dioxide by conversion of the carbon monoxide contained in the synthesis gas with water vapor, and
a PSA-H₂ unit for the purification of hydrogen and the production of a high-pressure gas stream of ultrapure hydrogen with associated production of a low-pressure gaseous waste, the two major constituents of which are carbon dioxide and hydrogen,
the method comprising:
installing an electrochemical hydrogen purification cell on the PSA low-pressure gaseous waste thereby separating hydrogen and a hydrogen-depleted waste from the PSA waste,
recovering the hydrogen to form an additional hydrogen stream which is compressed to a pressure of between 8 and 25 bar and
sending at least a portion of the compressed hydrogen stream to the inlet of the PSA unit to increase the hydrogen production of the plant while keeping the purity of the hydrogen produced by the PSA unchanged.

13. The debottlenecking method as claimed in claim 1, wherein, in the event of production of excess hydrogen, the operation of the electrochemical hydrogen purification cell is interrupted so as to optimize the power consumption of the plant

14. A hydrogen production process comprising the steps of:
a) generating, by reforming, a synthesis gas from a light hydrocarbon feedstock,
b) enriching the synthesis gas with hydrogen and carbon dioxide by steam conversion of the carbon monoxide to give carbon dioxide,
c) purifying the enriched synthesis gas for the production of a high-pressure gas stream of ultrapure hydrogen by pressure swing adsorption with associated production of a low-pressure gaseous PSA waste, the two major constituents of which are carbon dioxide and hydrogen,
d) supplying an electrochemical cell with at least part of the low-pressure PSA waste in order to recover additional hydrogen from the PSA waste, and a hydrogen-depleted waste,
e) compressing the additional hydrogen recovered to a pressure of between 8 bar and 25 barg, and
f) recycling all or part of the compressed recovered additional hydrogen in the process upstream of the PSA unit to supply the PSA so as to increase the production yield of very high purity hydrogen of the plant.

15. The process as claimed in claim 14, wherein step e) of compressing the additional hydrogen recovered is carried out at least in part by the electrochemical cell.

16. The process as claimed in claim 14, wherein at least one portion of the additional hydrogen recovered at the outlet of the electrochemical cell is used to desulfurize the light hydrocarbon feedstock prior to step a).

17. The process as claimed in claim 14, wherein at least part of the hydrogen-depleted waste leaving the electrochemical cell is recovered to produce carbon dioxide.

18. The process as claimed in claim 14, wherein at least one portion of the hydrogen-depleted waste leaving the electrochemical cell is used as reforming fuel.

19. A plant for producing hydrogen from a light hydrocarbon feed stream having an optimized yield comprising:
a module for generating, by reforming, a synthesis gas from said light hydrocarbon feed stream;
a module for steam conversion of the carbon monoxide to give carbon dioxide, for enriching the synthesis gas with hydrogen and carbon dioxide;
a PSA-H₂ unit for purifying the hydrogen contained in the synthesis gas with production of an outgoing high-pressure gas stream of ultrapure hydrogen and associated production of a low-pressure outgoing gaseous PSA waste, the two main constituents of which are carbon dioxide and hydrogen;
an electrochemical cell capable of being supplied by the low-pressure gaseous PSA waste and capable of separating hydrogen present in the PSA waste from the other constituents so as to produce a hydrogen stream and a hydrogen-depleted waste;
a means for compressing the hydrogen stream separated by the EHS cell;
a means for treating and/or a means for using the EHS cell waste; and
a means for discharging, conveying and supplying the various streams used.

20. The plant as claimed in claim 19, wherein the electrochemical cell is configured to carry out, at least in part, the compression of the additional hydrogen recovered.

21. The plant as claimed in claim 19, further comprising means for compressing and transferring at least a portion of the additional hydrogen recovered at the outlet of the electrochemical cell to a module for desulfurization of the light hydrocarbon feedstock.

22. The plant as claimed in claim 19, further comprising means for using the hydrogen-depleted waste leaving the electrochemical cell as a fuel for the reforming and/or for producing carbon dioxide.
